(19) United States
(12) Patent Application Publication
(10) Pub. No.: US 2016/0174472 A1
(43) Pub. Date: Jun. 23, 2016

(54) GROUND COVER AND NETTING MATERIALS

(71) Applicant: NINE IP LIMITED, Auckland (NZ)

(72) Inventors: Jonathan Dallas TOYE, Auckland (NZ); Suzanne Elizabeth FOY, Auckland (NZ)

(21) Appl. No.: 14/910,315

(22) PCT Filed: Aug. 8, 2014
(86) PCT No.: PCT/NZ2014/000164

§ 371 Date: Feb. 5, 2016

(30) Foreign Application Priority Data
Aug. 8, 2013 (NZ) 614075

(51) Int. Cl. A01G 13/00

(52) U.S. Cl. CPC A01G 13/0268

(57) ABSTRACT

The present invention relates to ground cover sheet materials and netting materials, and to ground cover sheets and netting comprising such materials. The materials comprise a green pigment derived from one or more pigments, and at least one additional pigment which does not significantly decrease the amount of solar radiation transmitted by the polymer-pigment mixture in the range of about 700 nm-2500 nm, and/or at least one additional pigment which decreases the amount of solar radiation transmitted by the material in the blue light range of about 440 nm-490 nm and in the red light range of about 620-700 nm.

### FIELD OF THE INVENTION

The invention relates to ground covers and ground cover materials and netting and netting materials.

### BACKGROUND TO THE INVENTION

Ground cover materials are used in agriculture for a number of purposes including weed suppression and/or soil warmth retention and/or moisture retention and/or for light reflecting. Netting materials may also be used for similar purposes in some situations.

Currently known important woven ground covers are as follows: black pigmented plastic ground cover; green pigmented plastic ground cover; and white pigmented plastic ground cover.

The black woven plastic ground covers warm the soil more than other pigmented ground covers.

Dark coloured pigmented plastic ground cover materials block light and are preferable for use in suppressing weeds. Black pigmented ground cover material may be used for weed suppression and for soil warming (by conduction of absorbed solar radiation).

Green materials to date, in particular ground cover materials, may provide sufficient light blocking properties for weed suppression, but do not provide soil warming properties better than black. Green ground cover materials may be preferred from an aesthetic perspective as they may blend in with the surrounding plants.

The white pigmented woven ground covers look to increase reflected light into the plant canopy. Hence they are more soil cooling than warming and are not as good as black covers for suppressing weeds.

Typically the material is rolled out in lengths onto the ground, and secured in place, beneath or between rows of trees, vines, or plants.

The sheet material may remain in place for some months, before being removed and reused in a subsequent growing season or on another crop in the same growing season, but in some cases may remain in place over multiple growing seasons.

It is an object of the present invention to provide improved ground cover and netting materials, or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect the present invention broadly consists in a ground cover sheet material, or a netting material for protecting plants, comprising:
a polymer and a green pigment derived from one or more pigments mixed to form a polymer-pigment mixture with solar radiation reflecting and absorbing or transmittance properties, and
at least one additional pigment added to the polymer-pigment mixture which does not significantly decrease the amount of solar radiation transmitted by the polymer-pigment mixture of the material in the range of about 700 nm-2500 nm, and/or
at least one additional pigment added to the polymer-pigment mixture which decreases the amount of solar radiation transmitted by the material in the blue light range of about 440 nm-490 nm and in the red light range of about 620 nm-700 nm.

The term “does not significantly decrease” as used herein with reference to an amount of solar radiation transmitted means that the amount of solar radiation transmitted is not decreased by more than 2%, 3%, 4%, 5%, 6%, 7%, 8%, 9%, 10%, 15%, 20%, 25% or 30%.

In another aspect the present invention broadly consists in a ground cover sheet material comprising:
a polymer and a green pigment (derived from either one or more pigments) mixed to form a polymer-pigment mixture with solar radiation reflecting and absorbing or transmittance properties, and
at least one additional pigment added to the polymer-pigment mixture to increase the amount of solar radiation transmitted by the polymer-pigment mixture in the range of about 700 nm-2500 nm.

The embodiments described herein may relate to any of the aspects described herein, as appropriate.

In some embodiments the at least one additional pigment added to the polymer-pigment mixture increases the amount of solar radiation transmitted by the polymer-pigment mixture in the range of about 700 nm-2500 nm.

In some embodiments the material comprises at least one additional pigment added to the polymer-pigment mixture which does not significantly decrease the amount of solar radiation transmitted by the material in the range of about 700 nm-2500 nm, and
at least one additional pigment added to the polymer-pigment mixture which decreases the amount of solar radiation transmitted by the material in the blue light range of about 440 nm-490 nm and in the red light range of about 620-700 nm.

In some embodiments the material comprises at least one additional pigment added to the polymer-pigment mixture which does not significantly decrease the amount of solar radiation transmitted by the material in the range of about 700 nm-2500 nm and/or which decreases the amount of solar radiation transmitted by the material in the blue light range of about 440 nm-490 nm and in the red light range of about 620-700 nm.

In some embodiments the at least one additional pigment increases, or at least does not decrease, the amount of solar radiation transmitted by the material in the range of about 700 nm-760 nm or 700 nm-800 nm.

In some embodiments the at least one additional pigment increases the absorption of blue light and/or red light in the material.

In some embodiments the material transmits more solar radiation than it reflects in the range of about 700 nm-2500 nm.

In some embodiments the material is substantially transparent to solar radiation in the range of about 700 nm-2500 nm.

In some embodiments the material at least partly absorbs solar radiation in the UV (about 280-400 nm) range and the visible (about 400-700 nm) range. In some embodiments the material absorbs at least 10%, 20%, 30%, 40%, 50%, 60%, 70%, 80%, 90% or 95% of solar radiation in the UV (about 280-400 nm) range. In some embodiments the material absorbs at least 10%, 20%, 30%, 40%, 50%, 60%, 70%, 80%, 90% or 95% of solar radiation in the visible (about 400-700 nm) range.

In some embodiments the green pigment is phthalocyanine green. In some embodiments the phthalocyanine green is provided in the amount of 0.5-5%, or 0.5-4%, or 0.5-3%, or 0.5-2%, or 0.5-1% by weight.

In some embodiments the material comprises iron oxide as an additional pigment. In some embodiments the iron oxide is provided in the amount of 0.2-5%, or 0.2-4%, or 0.2-3%, or 0.2-2%, or 0.2-1%, or 0.2-0.75% by weight.

In some embodiments, the iron oxide is red iron oxide. In some embodiments, the iron oxide is red Fe₂O₃ (Fe III). In some embodiments, the iron oxide is red heamatite Fe₂O₃ (Fe III). In some embodiments, the iron oxide is micronized.

In some embodiments the material comprises organic orange as an additional pigment. In some embodiments the organic orange is benzimidazolone. In some embodiments the organic orange is provided in the amount of 0.2-5%, or 0.2-4%, or 0.2-3%, or 0.2-2%, or 0.2-1%, or 0.2-0.4% by weight.

In some embodiments the material comprises silica as an additional pigment. In some embodiments the silica is provided in the amount of 0.2-5%, or 0.2-4%, or 0.2-3%, or 0.2-2%, or 0.2-1%, or 0.2-0.4% by weight.

In some embodiments the polymer comprises polyethylene or polypropylene or a mixture thereof.

In some embodiments the sheet is woven from warp and weft tapes. In preferred embodiments the warp tapes and the weft tapes have a rectangular cross-section. In other embodiments the sheet is in a form other than woven, such as a film.

In some embodiments the ground cover sheet has a length greater than its width. In some embodiments the width is at least 0.5 m, 1.0 m, 1.5 m, 2.0 m, 2.5 m, 3.0 m, 3.5 m, 4.0 m, 4.5 m, 5 m, 6 m, 7 m, 8 m, 9 m or 10 m, and its length is at least 10, 20, 30, 40, 50, 75, 100, 125, 150, 175, 200, 250, 300, 400 or 600 times its width.

In some embodiments the ground cover material is substantially transparent to solar radiation above about 700 nm. In some embodiments, the ground cover material is at least 55%, 60%, 65%, 70%, 75%, 80%, 85%, 90% or 95% transparent to solar radiation in the range about 700 nm to 2000 nm.

In some embodiments the ground cover material is more than 10%, 20%, 30% or 40% transparent to solar radiation across the wavelength range of 650 to 800 nm or 700-760 nm.

In another aspect the invention broadly consists in a netting material for protecting plants comprising a polymer and a green pigment mixed to form a polymer-pigment mixture with solar radiation reflecting and absorbing or transmittance properties, and
at least one co-pigment added to the polymer-pigment mixture to increase the amount of solar radiation transmitted by the polymer-pigment mixture in the range of about 700 nm-2500 nm.

In a another aspect the invention broadly consists in a ground cover material or netting material which is substantially transparent to solar radiation above about 700 nm and absorbs some solar radiation in the UV (about 280-400 nm) range and the visible (about 400-700 nm) range.

In some embodiments the material has more than 10% transparency to solar radiation across the wavelength range of 700 to 800 nm and absorbs more blue light (440 to 490 nm) than green light (490 to 570 nm), and absorbs more red light (620 to 780 nm) than green light (490 nm to 570 nm).

In some embodiments the material has average transmission across the wavelength range 900-1000 nm of at least 55, 58, 60, 62, 65 or 67 percentage points greater than the average wavelength across the 500-600 nm range.

In some embodiments the material transmits more than either 15%, 20%, 25%, 30%, 35%, 40%, 45%, 50%, 60%, 70%, 80%, 90%, or 95% of solar radiation across the wavelength range 700-800 nm, or across the wavelength range 700 to 760 nm.

In some embodiments the material transmits more than 30%, 40%, 50%, 60%, 70%, 80%, 90%, or 95% of solar radiation across the wavelength range 700 to 2100 nm.

In some embodiments the material absorbs more than either 20%, 30%, 40%, 50%, 60%, 70%, 80%, 90%, or 95% of the total of blue light plus red light and transmits more than either 20%, 30%, 40%, 50%, 60%, 70%, 80%, 90%, or 95% of green light.

In some embodiments the material reflects at least 10%, 20%, 30%, 40%, 50%, 60% or 70% of green light.

In some embodiments the material absorbs more than at least 10%, 20%, 30%, 40%, 50%, 60%, 70%, 80%, 90% or 95% of solar radiation in the UV range of about 280-400 nm.

In some embodiments the material transmits less than either 90%, 80%, 70%, 60%, 50%, 40%, 30%, 20% or 10% of solar radiation in the UV range of about 280-400 nm.

In some embodiments the material is colour stable for a period of at least 1.0, 1.5, 2.0, 2.5, 3, 4, 5, 6, 7, 8, 9, 10, 11 or 12 years. “Colour stable” as used herein means that the colour of the material has a light fastness of at least 7, preferably 8, on the blue wool scale. The blue wool scale is a measure of colour permanence, on a scale of 0 to 8. Colours with little permanence have a low value on the scale (e.g. 1 or 2), whereas colours with a high degree of permanence are rated at the high end of the scale (e.g. 7 or 8).

In some embodiments the material has CIELAB colour space coordinates of L*=32.1, a*=−6.64, and b*=4.13 or coordinates having a delta-E value of less than 24 of those readings. In some embodiments, the delta-E value is less than 6, 12, 18 or 24 of these coordinates.

In some embodiments the material has less than 0.5% or 0.3%, 0.1% or 0.05% by weight carbon black pigment, or contains no carbon black pigment.

In an another aspect the invention may broadly consist in a ground cover material or netting material (herein called ‘the material’) comprising:
a polymer or polymers and pigments together forming a polymer-pigment mixture, wherein the pigments comprise phthalocyanine green, iron oxide (for example, red iron oxide) and organic orange (benzimidazolone).

The ground cover sheet or netting may be made from tapes or monofilament or a combination of the two.

The tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate. Starch and other plant polymers are useful to increase biodegradability.

Alternatively the tapes may comprise in part or whole of paper, wood or cellulose fibre, starch based polymers, casein, latex or in any combination of the above and/or with petroleum derived plastic polymers. The polymer or polymer blend may incorporate agents such as one or more pigments, UV stabilisers, or processing aids.

In a further aspect the present invention provides a ground cover sheet or netting for use in horticulture comprising a ground cover material or netting material of the present invention.

Typically sheets of the invention will be laid out in lengths on the ground between or beneath rows of the crop being grown, which may be trees, vines, bushes etc. It is possible however that the covers or nettings may be suspended or positioned above the ground in a vertical or angled position to effect the solar radiation onto the crop, for example on either side of the crop row, for example trees.

The term “ground cover sheet material” or “netting material” as used herein refers to the materials which a ground cover sheet or netting comprise, with the terms “ground cover sheet” and “netting” having corresponding meanings. Transmission, absorbance and reflectance values as discussed herein are with reference to the materials (for example individual tapes or filaments) present in the ground cover sheet or netting, rather than the ground cover sheet or netting itself, unless otherwise stated.

The term “blue light” as used in this specification and claims means solar radiation across the wavelength range 440 to 490 nm.

The term “red light” as used in this specification and claims means solar radiation across the wavelength range 620 to 780 nm. The term as used herein therefore includes some wavelengths in the near infrared range, and more particularly includes near infrared that is in the photosynthetic active response range.

The term “green light” as used in this specification and claims means solar radiation across the wavelength range 490 to 570 nm.

The term “substantially transparent” as used in this specification and claims means having a transparency of at least 50%.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

A colour may be defined by the International Commission on Illumination (French Commission internationale de l'éclairage) colour space coordinates L*, a* and b* (CIELAB). In the CIELAB 3-dimensional colour space, one dimension L* is lightness, one dimension a* is colour extending from green (−a) to red (+a), and one dimension b* is colour extending from blue (−b) to yellow (+b). The rectangular colour coordinates a* and b* may be converted to polar form to be represented by hue (h°) being the angular component and chroma (C*) being the radial component. Colours of materials according to embodiments of the present invention may be defined by L*, and the rectangular coordinates a* and b* and/or the polar coordinates h° and C*.

A range of colours may be defined by a Delta-E metric that provides a measure of the difference between two colours, for example, the International Commission on Illumination CIE DE2000 Delta-E value. Unless otherwise specified, in this specification and claims, Delta-E is the CIE DE2000 value.

The L*, a* and b* measurements as used herein are defined with reference to an injection moulded chip of size 40 mm long by 50 mm wide and 1.1 mm thick, having a gloss finish. The injection moulded chips were moulded in high density polyethylene HHI302. The machine used to take the readings was a Datacolor SF600+CT spectrometer using a D65 light source for daylight conditions at 10% angle. The measurements are inclusive of gloss.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be further described by way of example only and with reference to the accompanying drawings, in which:

FIG. 1 is a schematic stylised plan view of a section of ground cover sheet of the invention;

FIG. 2a is an elevation view of woven ground cover sheets of the invention fixed to the ground beneath rows of trees or crops;

FIG. 2b is an elevation view of woven ground cover sheets of the invention fixed to the ground beneath rows of trees or crops;

FIG. 3 is a schematic perspective view showing the typical defining dimensions of rectangular cross-section warp or weft tapes used to weave the ground cover sheets of the invention;

FIG. 4 is a graph illustrating the effect of a ground cover material of the invention on mean daily soil temperature;

FIG. 5 is a graph comparing diffuse transmittance of a prior art green material to a prior art black material;

FIG. 6 is a graph comparing diffuse transmittance of a prior art green material to a material of the invention;

FIG. 7 is a graph comparing diffuse transmittance of a prior art “artificial grass” coloured green material to a material of the invention;

FIG. 8 is a graph comparing diffuse transmittance of a prior art white ground cover material to a material of the invention;

FIG. 9 is a graph illustrating diffuse transmittance of a green ground cover material of the invention compared to a prior art black ground cover material and a prior art white ground cover material;

FIG. 10 is a table of the data from which the graph of FIG. 9 was produced;

FIG. 11 is a table illustrating diffuse absorbance of a green ground cover material of the invention compared to a prior art black ground cover material and a prior art white ground cover material; and

FIG. 12 is a table illustrating diffuse reflectance of a green ground cover material of the invention compared to a prior art black ground cover material and a prior art white ground cover material.

### DETAILED DESCRIPTION OF PREFERRED EMBODIMENTS

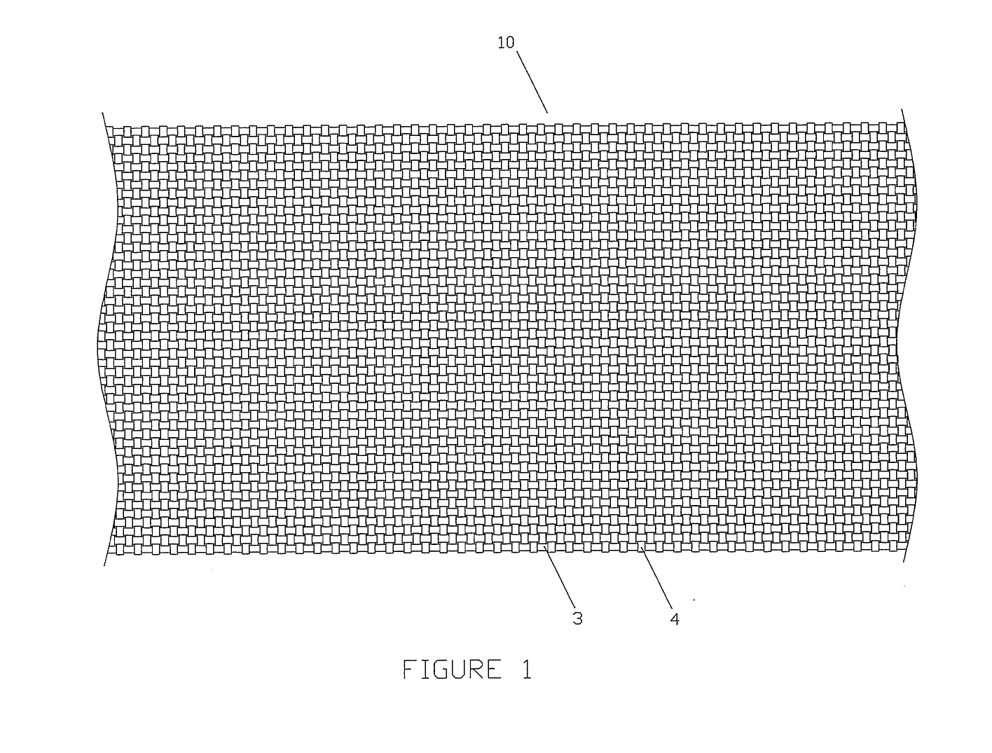

FIG. 1 shows a section of ground cover sheet 10. The sheet 10 is preferably woven from flat warp 3 and weft 4 tapes of a plastics material. Preferably the sheeting does not have gaps, holes, slits or openings greater than 1 mm in or between the tapes so as to minimise unwanted plant growth through the sheets. Normally there would be tape cramming (tape folding) between the tapes, to close out any gaps; this is not shown in the figure. The tapes may be formed by extruding a film material from a polymer resin and then cutting the film into tapes which are in turn used to weave the sheet, or by extruding individual tapes. The tapes may be formed from a polymer containing pigments which give the ground cover material desired properties, such as desired light reflective, absorptive and/or transmission properties for example.

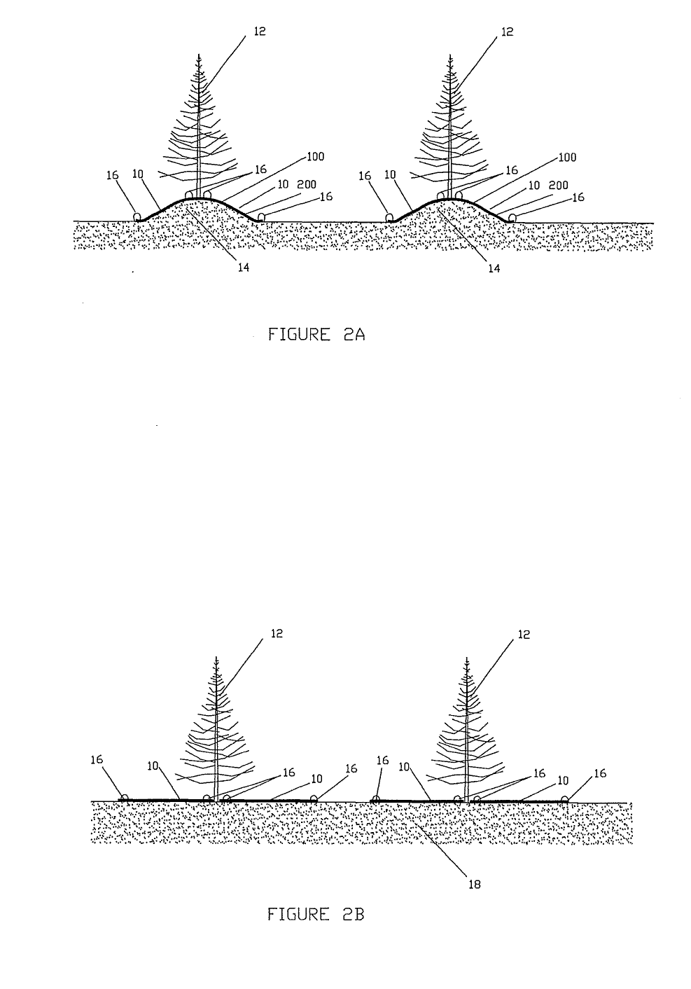

Typically the ground cover sheet has a greater length than width and is provided as a roll or in concertina folded form. Referring to FIG. 2a, lengths of the ground cover sheet 10 can be fixed between or beneath rows of crops, for example fruit trees 12, in various ways. The sheet is preferably staked or stapled to the ground by staples or pegs 16 hammered or pushed through the sheet and into the ground. FIG. 2a shows lengths of ground cover 100 laid on mounded soil 14. FIG. 2b shows lengths of ground cover sheet 10 laid on flat ground soil 18. It will be appreciated that the ground cover may be employed on any type of profile of ground surface, whether flat, mounded, sloped, undulating, contoured or a combination of these.

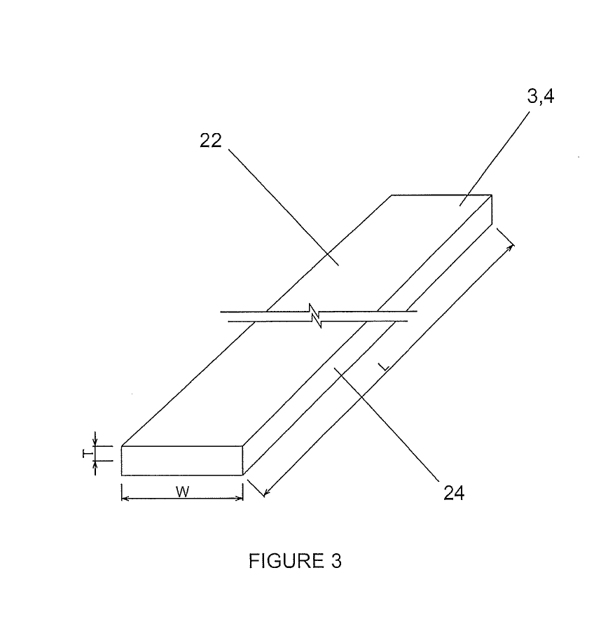

FIG. 3 shows dimensional profile and shape of substantially rectangular cross-section warp and/or weft tapes which may be used to weave the ground cover sheet, for the purpose of further explanation of the various embodiments of the ground cover material. The warp and/or weft tapes 3 and 4, have an indefinite length, designated by reference double-ended arrow L. The top and bottom surfaces 22 and 24 of the tape form the top and bottom surfaces of the ground cover sheet once woven. In this form the tapes are substantially rectangular in cross-section and have a width, designated by double-ended arrow W, and a thickness, designated by double-ended arrow T. It will be appreciated that the width and thickness of the tapes are substantially uniform along the length of the tape. In other forms the tapes may have different cross-section shapes, for example oval, round or square.

A ground cover sheet comprising green pigmented tapes may provide useful horticultural benefits in some applications. Some available green pigments are phthalocyanine green, chrome oxide green, chrome oxide green and chrome oxide yellow, nickel titanate, hydrated chromium sesquioxide and perylene black (organic).

In a preferred embodiment the ground cover sheet material comprises pigments, such as phthalocyanine green, organic orange (benzimidazolone), and iron oxide, which do not change chemically when exposed for long periods, such as years, to solar radiation. This is desirable for extending the life of the product. Pigments which are affected by solar radiation, such as UV light, become increasingly less transparent over time when exposed to the solar radiation, particularly in the 700 nm-2500 nm range.

In some embodiments the ground cover sheet material comprises a polymer and a combination of a green pigment such as phthalocyanine green, and an additional pigment, such as iron oxide, to form a polymer-pigment mixture. The inclusion of the iron oxide as an additional pigment with the green pigment supports the soil warming and weed suppression properties of the material.

In some embodiments the ground cover sheet material comprises a polymer and a combination of a green pigment such as phthalocyanine green, and an additional pigment such as organic orange (benzimidazolone), to form a polymer-pigment mixture. The inclusion of the benzimidazolone as an additional pigment with the green pigment supports the soil warming and weed suppression properties of the material.

In some embodiments the ground cover sheet material comprises a polymer and a combination of a green pigment such as phthalocyanine green, and two additional pigments such as iron oxide and organic orange (benzimidazolone), to form a polymer-pigment mixture. The inclusion of the iron oxide and the benzimidazolone as additional pigments with the green pigment increases the transmittance of solar radiation in the 550-600 nm range and the 700-800 nm range, compared to the same polymer-pigment mixture without the benzimidazolone added.

In some embodiments the ground cover sheet material comprises a polymer and a combination of a green pigment such as phthalocyanine green, two additional pigments such as iron oxide and organic orange (benzimidazolone) and an additional pigment such as silica, to form a polymer-pigment mixture. The inclusion of the iron oxide and the benzimidazolone and the silica as additional pigments with the green pigment increases the transmittance of solar radiation in the 550-600 nm range and the 700-800 nm range and decreases the transmittance of blue light and red light, compared to the same polymer-pigment mixture without the benzimidazolone added. The addition of the silica may increase the ability of the ground cover sheet material to hold heat in the soil from radiation above 2500 nm, this is achieved by reflection, and this is particularly beneficial for preventing the soil temperature decreasing rapidly once the solar radiation source is removed.

Increasing the amount of solar radiation transmitted by the cover increases the ability of the material to warm the soil. However, with the addition of suitable additional pigments, the resulting ground cover material preferably at least partly absorbs solar radiation in the UV (about 280-400 nm) range and the visible (about 400-700 nm) range. For example, in some embodiments the material absorbs more blue light (about 440-490 nm) and more red light (about 620-780 nm) than green light (about 490-570 nm). This supports the suppression of weeds but allows useful light to pass though for soil warming. The benefit of a material that is particularly transparent to solar radiation in the range above 700 nm but which absorbs (blocks) more blue and red light than green, and that allows green light to reach the soil below, is that the material provides for soil warming while also suppressing weeds growing beneath the ground cover. Green light passing through the ground cover material allows the solar energy to be transmitted to the soil underneath where it is converted to heat on absorption by the soil. This is more energy efficient than black ground cover materials where the energy is converted to heat and then transferred to the soil by conduction or convection (the black stops light getting through in the 400-700 nm range). However, effectively blocking the red and blue light suppresses weed/plant growth below the ground cover but allowing a portion of the green light to be transmitted.

A green ground cover may be particularly desirable as being a colour that blends in with the surrounding plants or ground. However, adding a pigment to improve some properties of the material can detrimentally change the colour of the material. In some embodiments the ground cover material comprises a main colour pigment (for example a green pigment), an active co-pigment (for example iron oxide) to impart desired solar radiation transmittance, reflection and absorbance properties, and a colour adjusting co-pigment to correct the colour change of the material caused by the addition of the active co-pigment.

In a preferred embodiment, the ground cover material comprises phthalocyanine green as a main colour pigment, iron oxide as an active pigment to affect the solar radiation transmittance, reflection and absorbance properties of the material, and organic orange (benzimidazolone), to provide a resulting polymer-pigment mixture comprising desired solar radiation properties and desired colour.

In some embodiments, the iron oxide is red iron oxide. The red iron oxide may be red Fe₂O₃ (heamatite). The iron oxide may in the form of micronized particles.

In particular in the 700-900 nm range, and more specifically the 700-800 nm range, and more specifically the 700-760 nm range, and even more specifically at the 700-750 nm range, the above pigment combination allows more transmission compared to existing green pigmented materials, which is good for increasing heat for soil warming. Also, the above pigment combination may provide a green that is closely matched to plant green colour so it is not offensive to look at, or blends in with the surrounding environment. Other greens may be more dark in colour which do not blend in as well or mimic green leaves as well.

In another embodiment, the ground cover material comprises phthalocyanine green as a main colour pigment, iron oxide as an active pigment to affect the solar radiation transmittance, reflection and absorbance properties of the material, organic orange (benzimidazolone), to provide a resulting polymer-pigment mixture comprising desired solar radiation properties and desired colour, and silica to provide additional soil warming during the night.

The skilled reader will understand that the pigments systems described above with reference to ground cover materials could also be applied to netting materials.

### Example 1

This example used a masterbatch in the form of thermoplastic granules containing 20% to 25% pigments of phthalocyanine green (11.5% w/w), iron oxide (6 to 8% w/w) and organic orange (benzimidazolone) (5% w/w) and a first polymer. The tapes were 50 micron oriented polypropylene tapes that were woven into the ground cover sheet.

Warp and weft tapes of the ground cover were formed by first extruding a second polymer, polypropylene, and the masterbatch containing the pigments of the invention at an addition rate of 6% masterbatch to 94% polypropylene on a cast extrusion line to form a film of about 200 microns. The resulting film was quenched in a water bath and drawn through rollers under tension to form a sheet. The sheet was then transported under tension to a slitting device with a plurality of knives and slit into a plurality of narrow slit tapes. The tapes were then stretched and mono-axially oriented by passing the tapes through two sets of heated rollers on either side of an oven with an air temperature set at 140 to 160 degrees Celsius. The second set of rollers is colder than the first set, and the speed of the second set of rollers is 7 times the speed of the first set of rollers, this enables stretching and molecular chain orientation to increase the strength of the tapes compared to unstretched tapes. The process of orienting the tapes reduced the thickness of the tapes from 200 microns to 50 microns. The warp and weft tapes in turn were then used to weave the ground cover sheet.

### Field Trial 1

A field trial was conducted to determine the effect that a cover according to the above example has on soil temperature compared to prior art black, prior art green and prior art white ground covers. The trial was set up on a blueberry farm in Moxee, Washington State, USA during spring to gain temperature data from beneath the weed mats being assessed. Green ground covers were compared to black weed suppression ground covers. All covers were made of polyethylene or polypropylene, had the same construction type and only varied in the colour/pigment chemistry of tapes used in their construction. More specifically, each was comprised of tapes 2.6 mm wide and 50 microns thick (about 2000 g/9000 m denier) woven from flat warp and weft tapes to give a resulting fabric of around 105 grams per square meter. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction.

The site chosen was part of an existing blueberry farm on a flat area facing east/west. Soil type was a sandy loam. The treatment plots were set up with mounded rows approximately 0.5 m high and 1 m wide. The experimental set up involved using replicated plots for each cover material type. Each plot was 15 m long and had 20+ individual bushes spaced at 0.75 m. There were a total of three rows per treatment, the two outside rows used as guard rows and centre row only used for assessments.

The ground covers were installed during early spring of the year 2012 when the plants were first planted. Temperature data loggers (Multitrip Data Logger, Temprecord) were installed at a depth of 20 cm beneath each ground cover treatment plot measuring soil temperature with data captured every 45 minutes.

### Results

Table is below is a comparison of mean soil temperatures for Spring Summer and Fall 2013 of a prior art black ground cover compared to a prior art green ground cover. The table shows slightly higher mean ground temperatures resulted from use of the black ground cover. Data is presented in degrees celcius.

TABLE 1a

| Season | Black | Prior Art Green |
|---|---|---|
| Spring (April-May 2013) | 15.0 | 14.9 |
| Summer (June-July 2013) | 23.5 | 23.4 |
| Fall (September-October 2013) | 15.9 | 15.9 |
| Weighted Average for 3 Periods | 18.9 | 18.8 |
| Difference compared to Black | 0 | −0.1 |

The slightly higher mean of the black is a result of high absorbance of solar radiation, resulting in the heating of the material itself and this heat being passed to the ground beneath by conduction or convection.

Table 1b below is a comparison of mean soil temperatures for Spring and Summer 2014 of a prior art black ground cover compared to a prior art green ground cover. The table shows higher mean ground temperatures resulted from use of the black ground cover. Data is presented in degrees celcius.

TABLE 1b

| Season | Black | Prior Art Green |
|---|---|---|
| Spring (April-May 2014) | 15.6 | 15.1 |
| Summer (June-July 2014) | 22.9 | 22.6 |
| Weighted Average for 2 Periods | 19.3 | 18.9 |
| Difference compared to Black | 0 | −0.4 |

The higher mean of the black is a result of high absorbance of solar radiation, resulting in the heating of the material itself and this heat being passed to the ground beneath by conduction or convection. The warmer sunny season of 2014 is showing a greater difference between the black over the prior art green.

Table 2 below is a comparison of mean soil temperatures for summer 2014 of the same prior art black and prior art green materials as above and including the new green ground cover material of example 1 above. The soil warming properties of the green ground cover of the invention are greater than either the black or prior art green ground covers. The higher mean of the green ground cover is a result of the high transmittance of infrared radiation and also high transmittance of green light heating the soil directly. Data is presented in degrees celcius.

TABLE 2

| Summer Month | Example 1 Green | Black | Prior Art Green |
|---|---|---|---|
| June 2014 | 22.1 | 21.2 | 20.1 |
| July 2014 | 25.3 | 24.6 | 24.3 |
| Weighted Average | 23.7 | 22.9 | 22.6 |
| Difference compared to Black | 0.8 | 0 | −0.2 |

### Field Trial 2

A further field trial was conducted to determine the effect that the green cover of example 1 would have on soil temperature compared to prior art black and prior art white ground covers. The trial was set up in Sunnyside Washington State, USA during summer to gain temperature data from beneath the ground covers being assessed.

Again, all three covers had the same construction type and only varied in the colour/pigment chemistry of tapes used in their construction. More specifically, each was comprised of tapes 2.6 mm wide and 50 microns thick (about 2000 g/9000 m denier) woven from flat warp and weft tapes. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction.

The trial site was on a south facing slope free of trees or other plants that may otherwise intercept sunlight. Soil type was a sandy loam. The trial rows were set up with flat rows, 1 m wide and 9 m long.

The ground covers were installed during late spring. Temperature data loggers (Multitrip Data Logger, Temprecord) were installed at a depth of 20 cm beneath each ground cover treatment plot measuring soil temperature with data captured every 10 minutes. Raw data was converted into daily mean, maximum and minimum temperatures for each ground cover type.

Over the period of the trial, there were consistent differences in the mean, maximum and minimum soil temperatures beneath each type of weed suppression mat. The results of the mean temperatures are presented in Table 3 below. Similar to the trial discussed above, the green ground cover of the invention produced significantly higher soil temperatures than the prior art black ground cover. The white ground cover was included for further comparison purposes. The results relating to the white show significantly lower temperatures than either the green or the black. Data is presented in degrees celcius.

TABLE 3

| Summer Month | Example 1 Green | Black | White |
|---|---|---|---|
| June 2014 | 23.7 | 22.7 | 20.7 |
| July 2014 | 26.5 | 25.8 | 22.5 |
| Weighted Average | 26.2 | 25.4 | 22.3 |
| Difference compared to Black | 0.9 | 0 | −3.1 |

Significantly less weed growth was observed under both the black ground cover and green ground cover than under the white ground cover. The white ground cover is not suitable to sufficiently suppress weeds in this situation where there is no crop to reduce the solar radiation on the material.

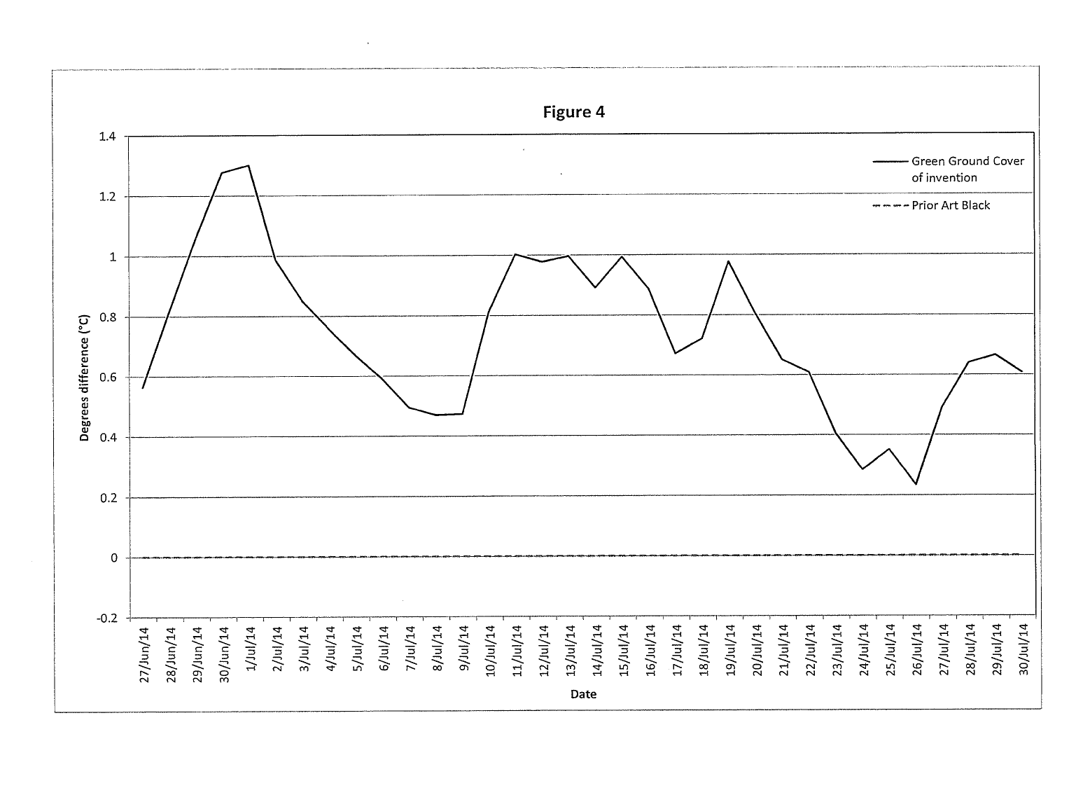

FIG. 4 illustrates data from the above trial shown in graphical form. In the figure, the green ground cover of the invention has been compared to the black ground cover, using the temperature data from the black ground cover as a baseline. The figure shows a mean daily soil temperature for the green ground cover of the invention being consistently higher than the black ground cover.

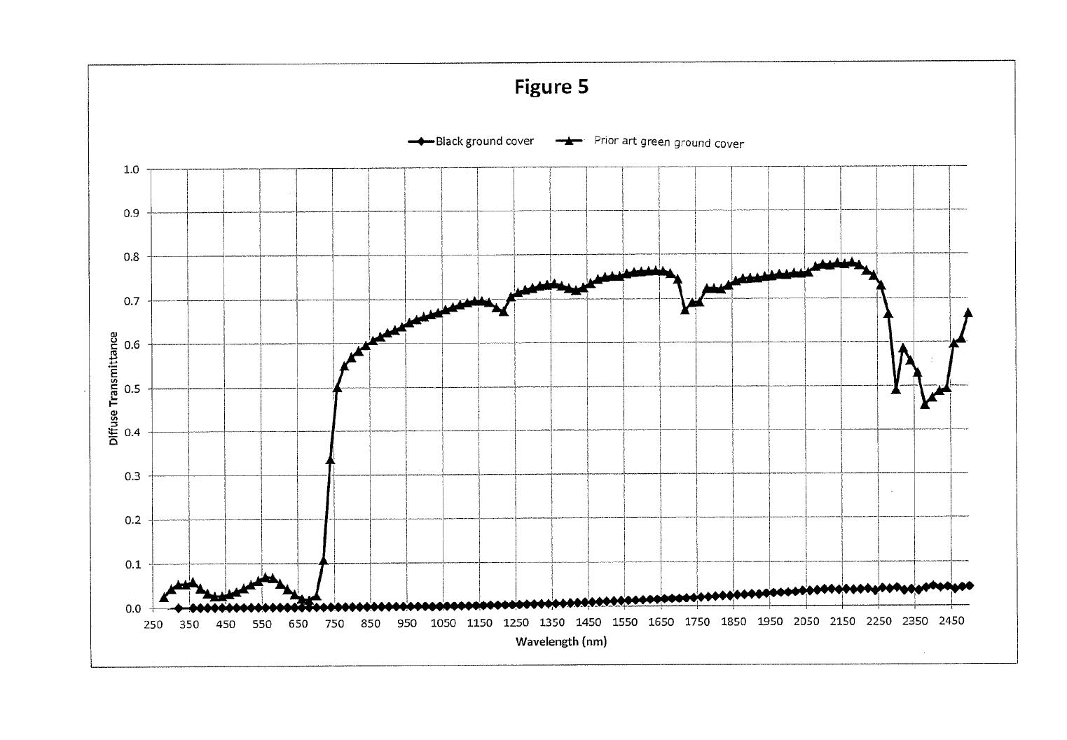

FIG. 5 is a graph comparing diffuse transmission data of a prior art green ground cover material compared to a prior art black ground cover material. The graph shows the low transmittance of the black ground cover material across the visible (400-700 nm) wavelengths. It is an effective weed suppression ground cover material and this is a result of low transmission across these wavelengths. The prior art green ground cover material also has low transmission across the visible wavelengths and is also an effective weed suppressant. Despite the difference in transmission profile between the ground cover materials, they provide generally similar the same soil warming properties as the black.

The black absorbs all of the solar radiation and converts it to heat that is then conducted to the soil. The prior art green allows the transmission of solar radiation beyond the 750 nm wavelengths to gain a similar resulting transference of solar radiation, the final soil temperature results, to the soil but by a different method.

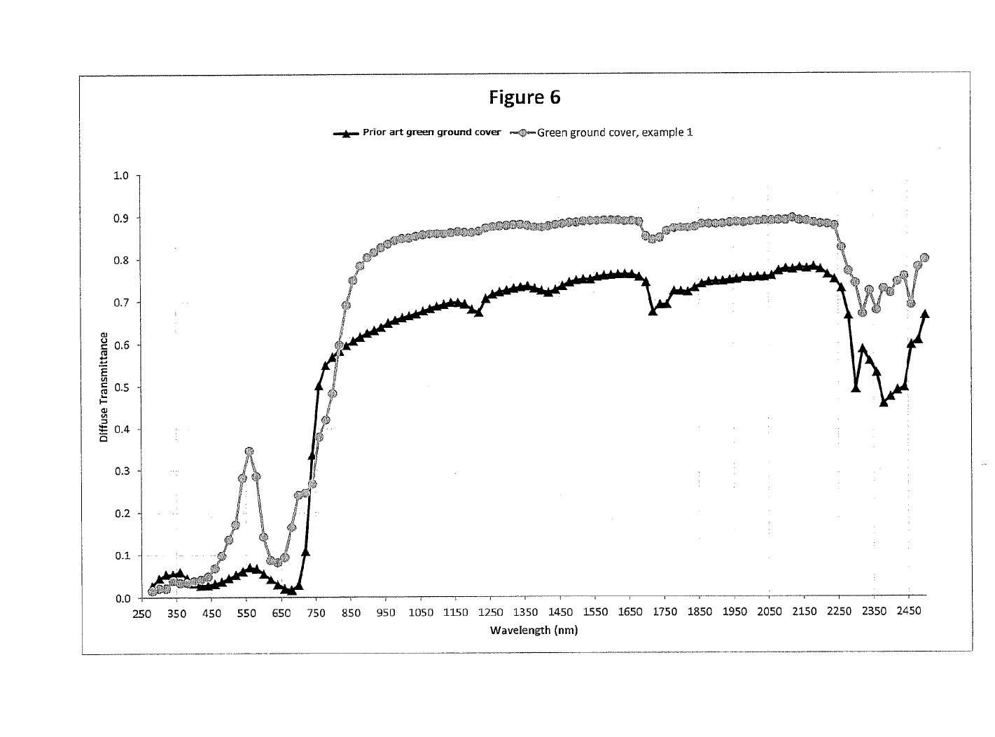

FIG. 6 is a graph comparing diffuse transmission data of a prior art green ground cover materials compared to the green ground cover material of example 1. Higher transmittance can be seen for the green ground cover material of example 1 across the wavelengths from about 400 to about 740 nm and also 780 nm to 2100 nm, and higher. In particular, there is significantly higher transmittance across the green wavelengths (490-570 nm), and 780 to 2100 nm, and above. These properties result in the green ground cover material of example 1 providing soil warming benefits to soil beneath the ground cover sheet. Also, transmission across the blue (440-490 nm) and red (620-700 nm) wavelengths is still relatively low, which means effective weed suppression. This gives the green cover material similar weed suppression results of the prior art green but higher soil warming properties.

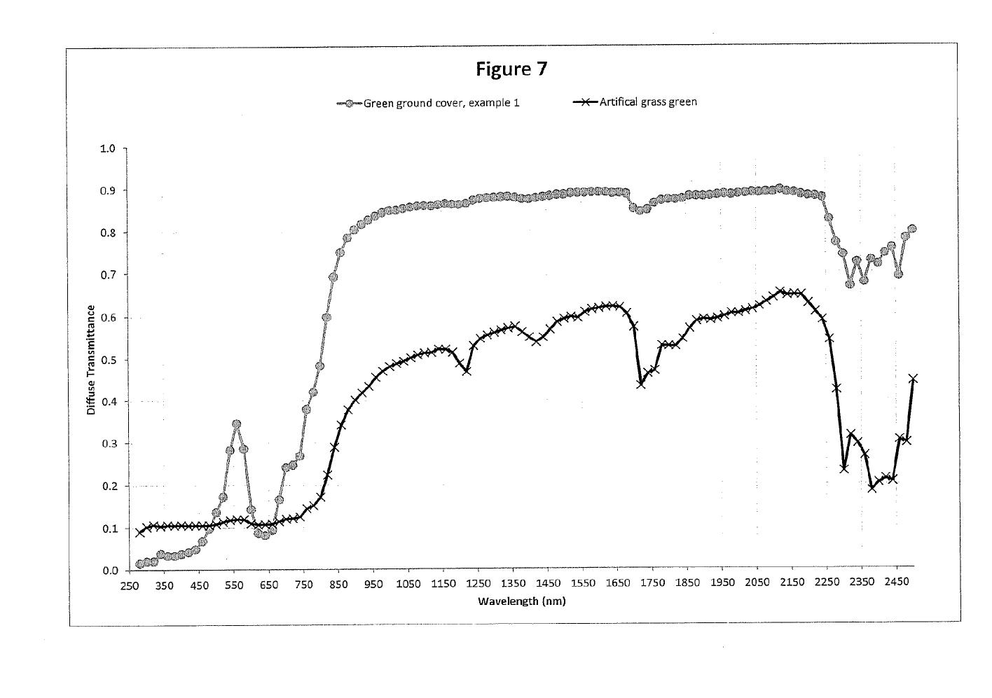

FIG. 7 is a graph comparing diffuse transmission data of an “artificial grass” coloured green ground cover material compared to the green ground cover material of example 1. Both materials have a similar visual appearance to the human eye, they look like green leaf color materials. Transmittance across the green wavelengths (490-570 nm) and across wavelengths greater than about 700 nm is significantly higher for the green ground cover material of example 1 than the artificial grass green. The green ground cover of example 1 provides significantly better soil warming due to this difference. The graph also shows the relatively high transmittance across the wavelength range 700 to 760 nm. While not wishing to be bound by any particular theory, the applicant of the present application believes that the high transmittance across this range is important for providing the soil warming benefits that the present invention may provide.

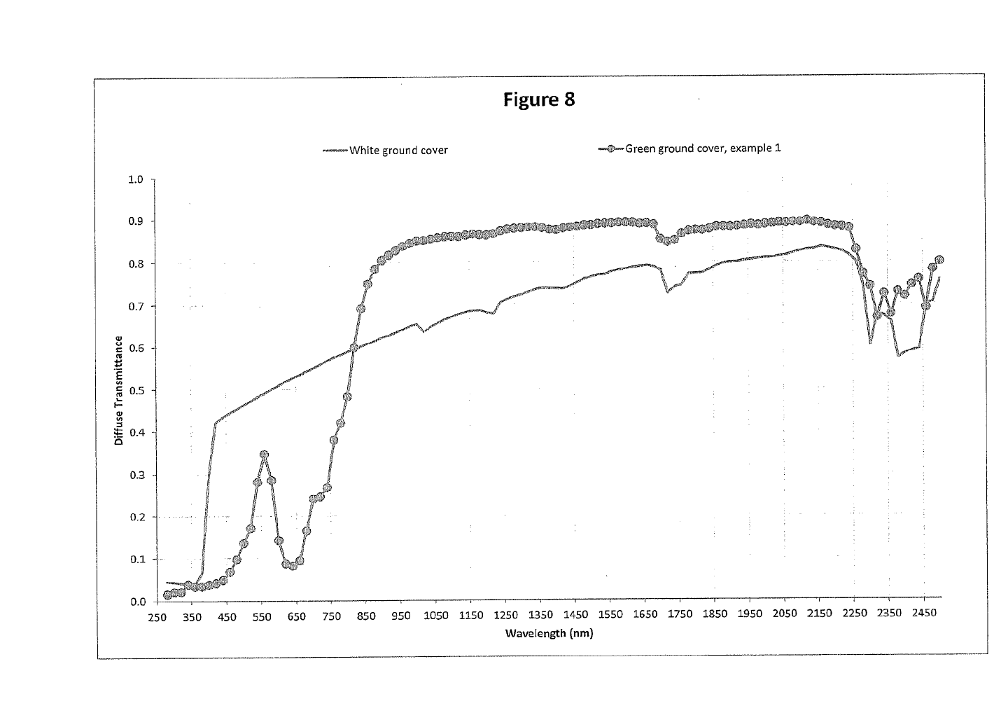

FIG. 8 is a graph comparing diffuse transmission data of a prior art white ground cover material compared to the green ground cover material of example 1. The graph shows much greater transmission of the white ground cover material across the 400-700 nm range, and therefore a poor weed suppression, and much lower transmission across the 800-2100 nm range, and therefore poor soil warming compared to green ground cover material of example 1.

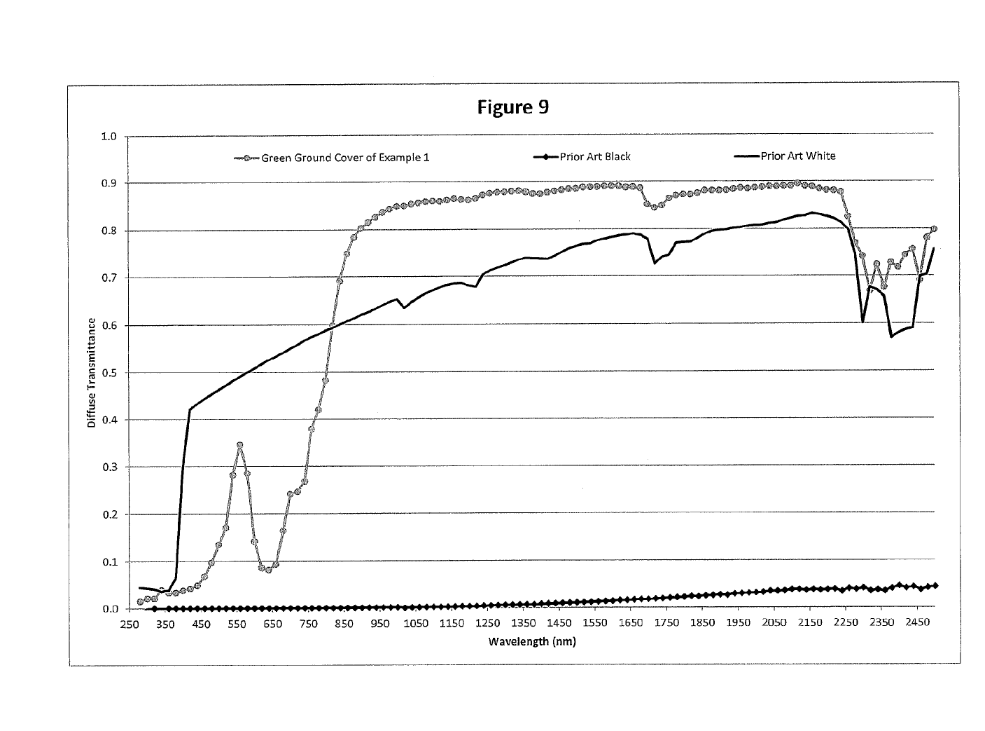

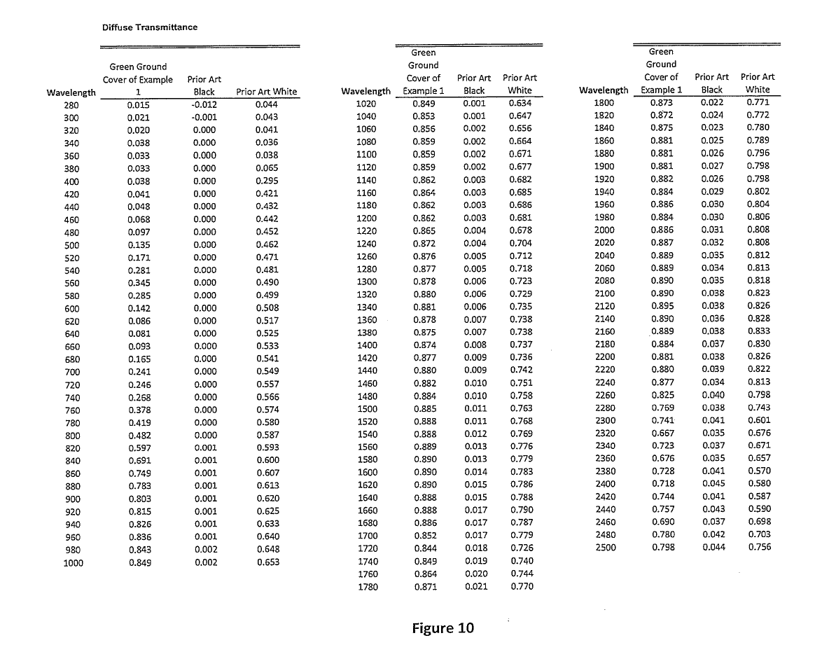

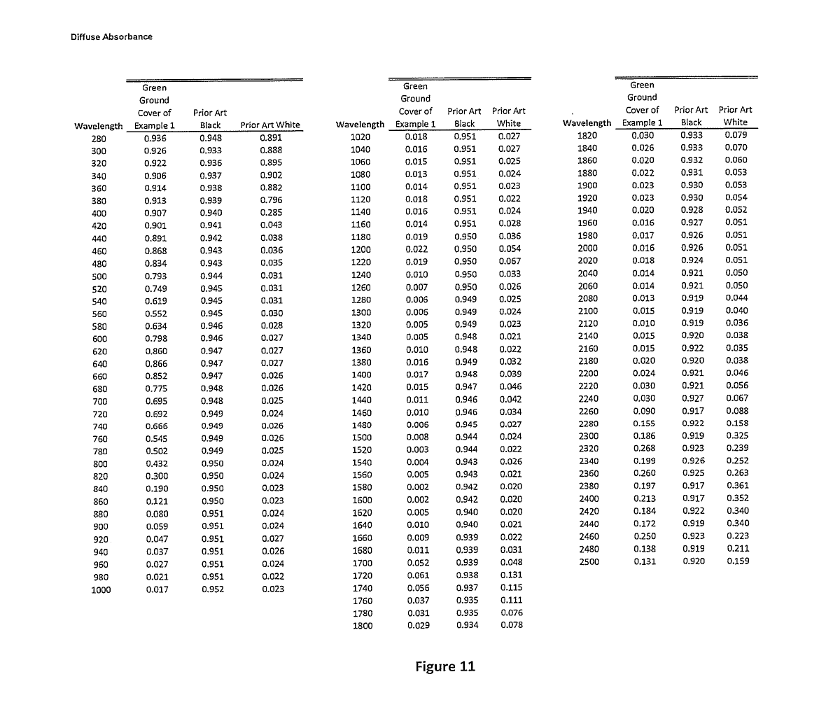

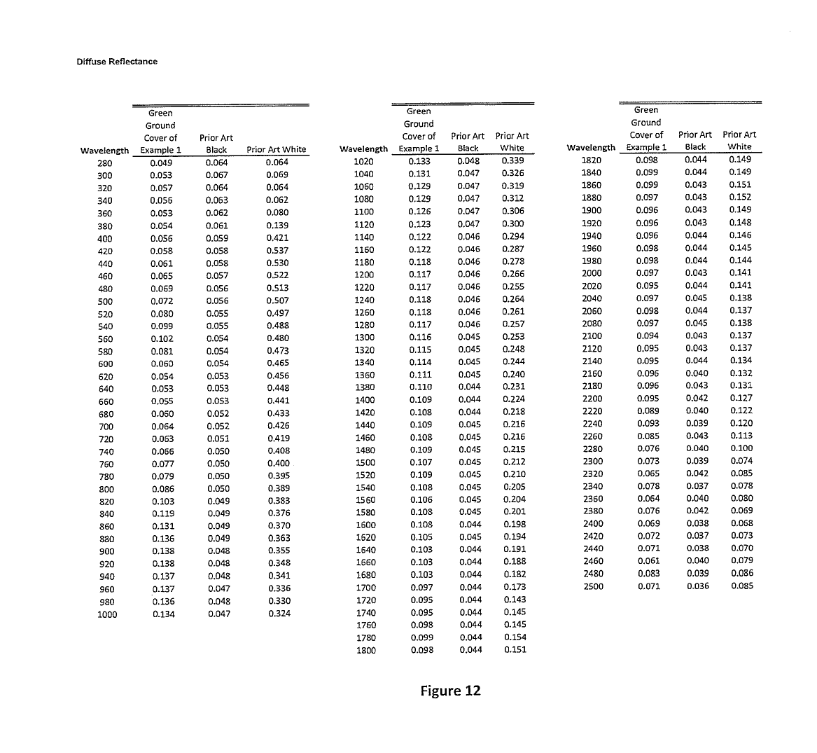

FIGS. 9 to 11 are a graph and tables comparing transmittance, absorbance and reflectance of the green ground cover material of example 1 above to a prior art black ground cover material and a prior art white ground cover material. With reference to FIG. 9 in particular, it can be seen that the prior art black material transmits very little visible (400 to 700 nm) solar radiation. It is an effective weed suppression ground cover and this is a result of its low transmission properties. In contrast, the prior art white material can be seen to have relatively high transmittance of visible solar radiation, and its poor weed suppression is a result of this. The green ground cover material of example 1 is shown as having low transmission across blue and red light, but higher transmittance of green light. This transmission profile allows the green ground cover material of example 1 to act as an effective weed suppressant. Further, transmission of radiation of wavelengths above 700 nm is also high for the green ground cover material of example 1, allowing effective soil heating to occur as well.

The preferred colour of the materials of the invention has CIELAB coordinates of L*=32.1, a*=−6.64, b*=4.13 or within a delta-E value of 6, 12, 18 or 24 of these coordinates.

The following is a description of the spectrophotometer system and measuring method used for measuring solar radiation transmittance values quoted in the specification unless otherwise stated.

In this specification, diffuse transmittance data has been measured of individual tapes of each relevant material, opposed to the ground cover sheet or netting as a whole, unless otherwise stated. The method of measurement is described below.

The spectrophotometer system is based around a GSA/McPherson 2051 1 metre focal length monochromator fitted with a prism predisperser and also stray light filters. The light source is a current regulated tungsten halogen lamp. The bandwidth is adjustable up to 3 nm. The monochromatic beam from the monochromator is focused onto the sample or into the integrating sphere using off-axis parabolic mirrors. The integrating spheres are coated with pressed halon powder (PTFE powder). Halon powder is also used as a white reflectance reference material. The detector is usually a silicon photodiode connected to an electrometer amplifier and digital volt meter. The whole system is controlled using software written in LabVIEW. The detectors used can be photomultiplier tubes, silicon diodes or lead sulphide detectors.

### Diffuse Reflectance Sphere.

Diffuse reflectance was measured using an integrating sphere with an internal diameter of 75 mm and the sample tilted at an angle of 6° to the incident light (specular reflectance included). The reference sample is pressed halon powder and a black cone is used to correct for stray light. Up to four test samples are mounted on a pneumatic driven sample changer along with the white reference and black cone.

### Diffuse Transmittance Sphere

Diffuse transmittance was measured using an integrating sphere with an internal diameter of 120 mm and coated with pressed halon powder. The sample is mounted on one port and the incident light port is at an angle of 90° around the sphere. The sphere rotates by 90° in the horizontal plane to allow the focused incident light to enter the sphere through the incident light port or the incident light to be transmitted through the sample and enter the sphere. The detector is mounted at the top of the sphere.

Various embodiments are described with reference to the Figures. The same reference numerals are used throughout to designate the same or similar components in various embodiments described.

The foregoing description of the invention includes preferred forms thereof. Modifications may be made thereto without departing from the scope of the invention as defined by the accompanying claims.

1. A ground cover sheet material, or a netting material, for protecting plants, comprising:
a polymer and a green pigment derived from one or more pigments mixed to form a polymer-pigment mixture with solar radiation reflecting and absorbing or transmittance properties, and
at least one additional pigment added to the polymer-pigment mixture which does not significantly decrease the amount of solar radiation transmitted by the polymer-pigment mixture in the range of about 700 nm-2500 nm.

2. A material according to claim 1, wherein the at least one additional pigment added to the polymer-pigment mixture decreases the amount of solar radiation transmitted by the material in the blue light range of about 440 nm-490 nm and in the red light range of about 620-700 nm.

3. A material according to claim 1, wherein the at least one additional pigment added to the polymer-pigment mixture increases the amount of solar radiation transmitted by the polymer-pigment mixture in the range of about 700 nm-2500 nm.

4. A material according to claim 1, wherein the at least one additional pigment increases or at least does not decrease the amount of solar radiation transmitted by the material in the range of about 700 nm-800 nm.

5. A material according to claim 1, wherein the at least one additional pigment increases, or at least does not decrease, the amount of solar radiation transmitted by the material in the range of about 700 nm-760 nm.

6. A material according to claim 1, wherein the material transmits more solar radiation than it reflects in the range of about 700 nm-2500 nm.

7. A material according to claim 1, wherein the material is substantially transparent to solar radiation in the range of about 700 nm-2500 nm.

8. (canceled)

9. A material according to claim 1, wherein the green pigment is phthalocyanine green.

10. (canceled)

11. A material according to claim 1, wherein the material comprises iron oxide as an additional pigment.

12. (canceled)

13. A material according to claim 1, wherein the material comprises organic orange as an additional pigment.

14. A material according to claim 1, wherein the organic orange pigment is benzimidazolone.

15. (canceled)

16. A material according to claim 1, wherein the material comprises silica as an additional pigment.

17-20. (canceled)

21. A ground cover sheet material or netting material that is substantially transparent to solar radiation above about 700 nm and absorbs some solar radiation in the UV range of about 280-400 nm and some of the visible range of about 400-700 nm, and wherein the average transmission across the wavelength range 900-1000 nm is at least 55, 58, 60, 62, 65 or 67 percentage points greater than the average wavelength across the 500-600 nm range.

22. (canceled)

23. A material according to claim 21, wherein the material transmits more than either 15%, 20%, 25%, 30%, 35%, 40%, 45%, 50%, 60%, 70%, 80%, 90%, or 95% of solar radiation across the wavelength range 700-800 nm, or across the wavelength range 700 to 760 nm.

24. A material according to claim 21, wherein the material transmits more than 30%, 40%, 50%, 60%, 70%, 80%, 90%, or 95% of solar radiation across the wavelength range 700 to 2100 nm.

25-28. (canceled)

29. A ground cover material or netting material comprising:
a polymer or polymers and pigments together forming a polymer-pigment mixture, wherein the pigments comprise phthalocyanine green, iron (III) oxide and organic orange.

30. (canceled)

31. A material according to claim 29, wherein the material is made from tapes or monofilament or a combination of the two.

32-33. (canceled)

34. A material according to claim 1, that has less than 0.5% or 0.3%, 0.1% or 0.05% by weight carbon black pigment, or contains no carbon black pigment.

35-42. (canceled)

43. A material according to claim 21, wherein the material has more than 10% transparency to solar radiation across the wavelength range of 700 to 800 nm and absorbs more blue light (440 to 490 nm) than green light (490 to 570 nm), and absorbs more red light (620 to 780 nm) than green light (490 nm to 570 nm).

44. A material according to claim 1, wherein the material is a film.
